(19) United States
(12) Patent Application Publication
(10) Pub. No.: US 2018/0335998 A1
(43) Pub. Date: Nov. 22, 2018

(54) ROAMING CLIPBOARD COPY/PASTE

(71) Applicant: Microsoft Technology Licensing, LLC, Redmond, WA (US)

(72) Inventor: David Michael Callaghan, Duvall, WA (US)

(21) Appl. No.: 15/597,030

(22) Filed: May 16, 2017

(51) Int. Cl. G06F 3/14; G06F 3/0482; G06F 3/0484; H04L 29/08

(52) U.S. Cl. CPC G06F 3/1454; G06F 3/0482; H04L 67/1097; H04L 67/36; G06F 3/0484

(57) ABSTRACT

Various embodiments of the present technology generally relate to smarter copy and paste tools. More specifically, some embodiments relate to roaming copy and paste tools that allow data copied from one device to be pasted on another device. For example, in response to a request to copy selected data available on a first device, the data is copied and stored in a roaming clipboard, buffer, memory, or file. When a user associated with the first device submits a paste request on a second device, the data stored in the roaming clipboard or file is pasted on the second device.

### BACKGROUND

Modern electronic devices (such as mobile phones, computers, tablets, wearables, and the like) provide users a variety of advanced computing and communication capabilities. Over time, these devices have become smaller, more powerful, and cheaper. As a result, users often have multiple electronic devices which are generally tailored to specific activities or convenience factors (e.g., portability). For example, users of electronic devices routinely utilize some type of personal productivity software that often includes a variety software applications. These software applications can include word processors, spreadsheet applications, e-mail clients, notetaking software, presentation applications, and others. The applications available in these software suites are often used by individuals in school and business to create documents, presentations, and various reports. These applications can also be used to perform calculations, produce charts, organize data, receive and send e-mails, and the like.

In many cases, users are copying portions of data within one of the software applications and pasting that data to a new location within the same or different software application. This works very well when the user is copying and pasting on the same device. However, as users become more integrated with multiple devices there is no easy way to paste material copied on one device to a second device. Traditionally, in order to resolve this issue, users often have to open the same document or webpage on the second device and perform the copy action again. Getting the correct document and web page links on the second device can be challenging. For example, some users may copy and paste the content from a first device to an email or text message they send to themselves and open on the second device to get the content or links to the information. After getting the content or links to the information on the second device, the users then copy and paste from the text/email application into the document on the second device. These additional steps can be burdensome on users.

Overall, the examples herein of some prior or related systems and their associated limitations are intended to be illustrative and not exclusive. Upon reading the following, other limitations of existing or prior systems will become apparent to those of skill in the art.

### OVERVIEW

Various embodiments of the present technology generally relate to systems and methods for copying and pasting data. More specifically, some embodiments provide for systems and methods for implementing improved copy and paste features that can be used across multiple devices. For example, some embodiments provide for a roaming clipboard that allows material copied from one device to be easily and effortlessly pasted on a second device. Some embodiments provide for a method that includes receiving, at a cloud-based document storage platform, a first request to open a document on a first electronic device. The cloud-based document storage platform can verify the identity of the requestor and allow or deny access to the document. Once the document is opened, data (e.g., text, pictures, or other material) can be copied from the document opened on the first electronic device. The copied data can be received and stored at the cloud-based storage platform.

In some embodiments, the data copied from the first electronic device can be stored at the cloud-based document storage platform in a side car file appended to the document, using a buffer associated with the user, in a temporary memory, or the like. The data can then be transmitted from the cloud-based document storage platform to a second electronic device to allow the user to paste the data in a selected location at the second electronic device even though the copy command originated at the first electronic device thereby creating a roaming clipboard. In some embodiments, the roaming clipboard may be associated with the document opened via the cloud-based document storage platform. However, other embodiments allow for a roaming clipboard that is just associated with a user and is available on any device no matter where the material was copied.

One benefit of the roaming clipboard is that the roaming clipboard can span across various platforms like mobile phones, PC, gaming consoles, digital whiteboards, and virtual and/or augmented reality scenarios even when the devices are provided by different manufacturers and possibly run different operating systems, CPU architectures and otherwise have not direct connection between the devices. Various embodiments of the present technology also contemplate group collaboration scenarios like multiple users who can copy and paste data into a document from a shared workspace in new ways such as a user copying content to their clipboard on a mobile device and then directly passing the clipboard content to a colleague who can paste the content into a document using a different computing device.

The copied data can be stored in a variety of formats and with a variety of additional information or metadata. This additional information or metadata may be presented to the user as optional information to include in pasting options. For example, some paste operations may allow the user to insert the copied data as an image, as a file, as an attachment, or the like. The pasting command may originate via a graphical user interface, keyboard keystrokes, mouse clicks, voice commands, onscreen touch enabled buttons, user interface that supports gestures, etc.

Embodiments of the present invention also include computer-readable storage media containing sets of instructions to cause one or more processors to perform the methods, variations of the methods, and other operations described herein.

Some embodiments provide for a system having one or more processors, memory, a communication component, a storage module, a graphical user interface generation module, and applications (e.g., spreadsheet applications, presentation applications, etc.). The communication component can be configured to connect the system to a first client device and a second client device. The communication component can also be configured to receive data copied within an application opened on the first client device. The storage module can store the data copied from the application opened on the first client device. Then, the communication module transmits the data to the second client device to allow the user to paste the data in a selected location on the second client device. In some embodiments, the graphical user interface generation module can present a graphical user interface in response to a pasting request on the second client device. The graphical user interface can include a first option to paste the first set of data copied from the first client device, a second option to paste from a local clipboard available only on the second client device, and/or a third option to paste from another collaborator who may or may not have access to the document itself.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Embodiments of the present technology will be described and explained through the use of the accompanying drawings in which:

FIG. 1 illustrates an example of an environment capable of implementing copy and paste operations across multiple devices in accordance with some embodiments of the present technology;

FIG. 2 illustrates an example of a set of operations for copy and paste operations according to one or more embodiments of the present technology;

FIG. 3 illustrate a set of components associated with a cloud-based collaboration service supporting an enhanced copy and paste that may be used in one or more embodiments of the present technology;

FIG. 4 illustrates a set of components that may be used according to one or more embodiments of the present technology;

FIG. 5 illustrates an example of a set of operations for allowing a user to paste data from local and/or roaming clipboards in accordance with some embodiments of the present technology;

FIG. 6 is a sequence diagram illustrating an example of the data flow between various components according to various embodiments of the present technology; and

FIG. 7 illustrates an example of a computing system, which is representative of any system or collection of systems in which the various applications, services, scenarios, and processes disclosed herein may be implemented.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to systems and methods for copying and pasting data. More specifically, some embodiments provide for systems and methods for implementing improved copy and paste features that can be used by individual authors and teams collaborating across multiple devices. Consumers often have access to multiple devices with different form factors such as smartphones, tablets, personal computers, smart televisions, augmented and/or virtual reality headsets etc. These devices can include work devices (e.g., computers, tablets, smartphones, etc.) as well as personal devices (e.g., laptops, tablets, wearable computing devices, etc.). There are many instances where users have a document or webpage open on one device and would like to copy the data or material to a location on the second device (e.g., an e-mail or text). Unfortunately, traditional copy and paste operations require the user to open the document on the second device, copy the material, and then paste the material in the desired location on the second device. As a result, users of traditional copy and paste features have to either manually recreate the data or perform additional operations such as sending an email or text message with the content or URL to themselves on the second computing device so they can copy and paste from the message or URL into the actual desired document.

In contrast, various embodiments eliminate these additional user interactions by automatically using a roaming clipboard that makes data copied on one device available for pasting on additional devices. Moreover, various embodiments of this enhanced copy and paste functionality can be especially useful for individuals who utilize multiple devices, such as a laptop and a mobile phone. In addition, some embodiments of this copy and paste functionality can be applied to specifically to documents created in spreadsheet applications, word processing applications, e-mail applications, and/or other applications having data a user may create, copy, and/or paste into other documents or applications.

Various embodiments of the present technology provide for a wide range of technical effects, advantages, and/or improvements to computing systems and components. For example, various embodiments include one or more of the following technical effects, advantages, and/or improvements: 1) reducing the number of user interactions when copying and pasting data; 2) automatically identifies additional data needed to manage a roaming clipboard; 3) creates a new format for storing data with a clipboard or memory; 4) creates improvements to the way computing devices operate; 5) uses unconventional and non-routine operations as part of the copy and paste process to automatically copy data to a roaming clipboard that may be accessed by additional devices or users; 6) uses additional graphical user interfaces for selecting between various pasting options enabled by the enhanced copy/paste tools having access to multiple clipboards; and/or 7) changing the manner in which a computing system reacts to a request to copy and paste data. Some embodiments include additional technical effects, advantages, and/or improvements to computing systems and components.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. While, for convenience, embodiments of the present technology are described with reference to creating smarter copy and paste functionality using a cloud-based roaming clipboard, embodiments of the present technology are equally applicable to various other instantiations such as, but not limited to, direct communication between multiple computing devices where one or more maintains the roaming clipboard. Similarly, in some embodiments various types of information may be automatically collected in response to a copy command Examples include, but are not limited to, file name, date/time of copy/paste request, user information (e.g., initials), titles, headings, and/or other information that may be beneficial. Additionally, in some embodiments the copy and paste operation can interoperate between a graphical user interfaces and what are traditionally considered non-graphical user interfaces such as command line interfaces such the text editor vi (currently available at ex-vi.sourceforge.net), Microsoft Windows PowerShell, and the Unix Bash shell.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

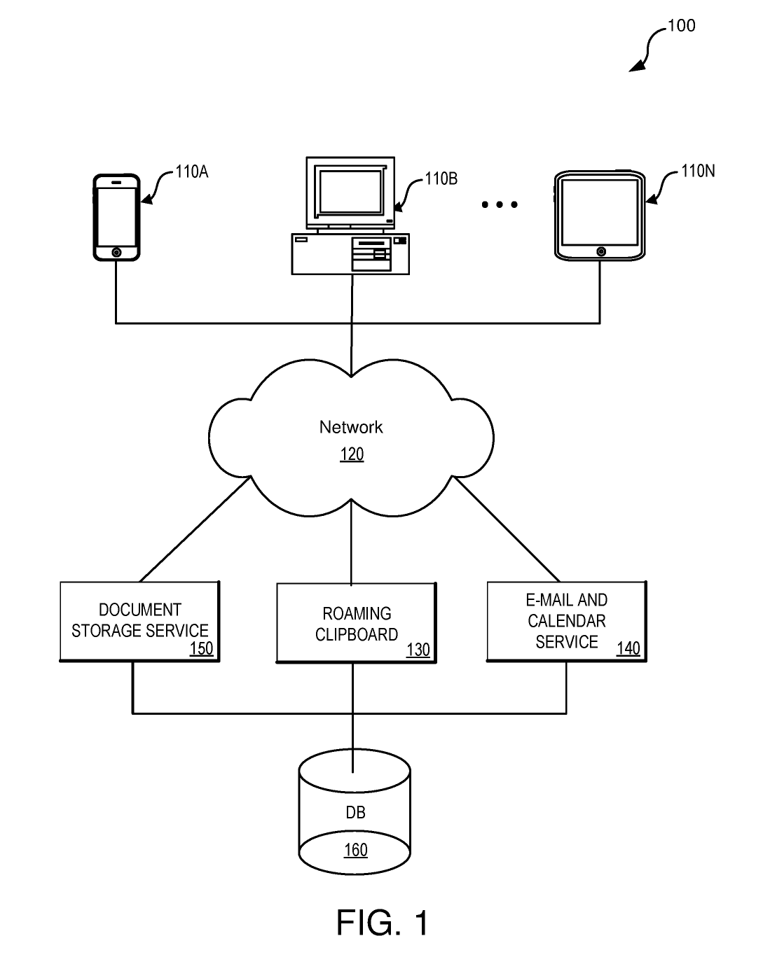

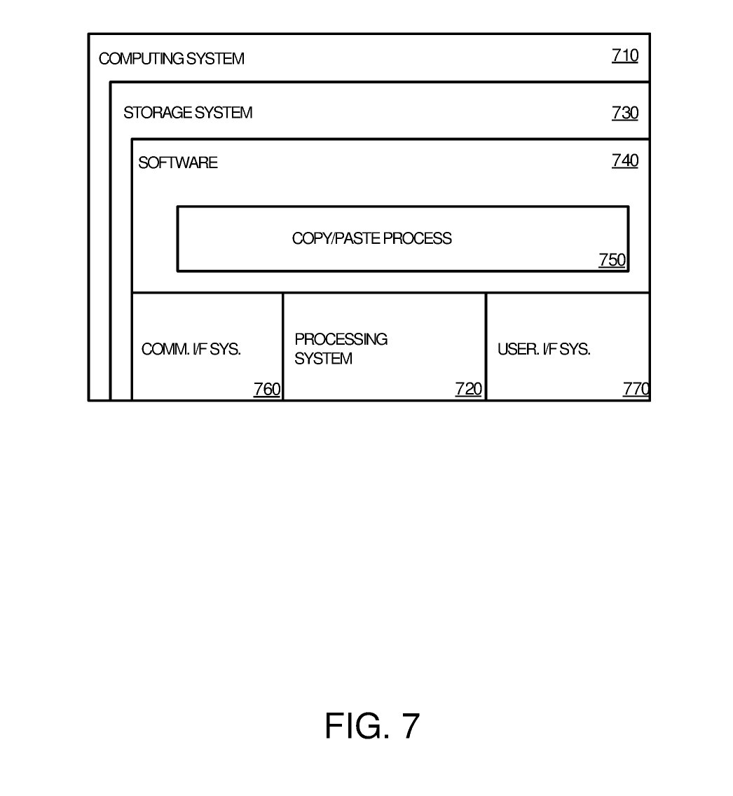

FIG. 1 illustrates an example of an environment 100 capable of implementing enhanced copy and paste operations in accordance with some embodiments of the present technology. As illustrated in FIG. 1, environment 100 may include one or more computing devices 110A-110N, communications network 120, remote servers running roaming clipboard 130, e-mail and calendar service 140, document storage platform or service 150, and database 160. Computing devices 110A-110N are representative of any computing system capable of running an application natively or in the context of a web browser, streaming an application, or executing an application in any other manner Examples of computing system 110 include, but are not limited to, personal computers, mobile phones, tablet computers, desktop computers, laptop computers, wearable computing devices, thin client computing devices, virtual and/or augmented reality computing devices, virtual machine hosting a computing environment, distributed application, server computer, computing cluster, application hosted as software as a service (SaaS), application running on a platform as a service (PaaS), application running on an infrastructure as a service (IaaS) or any other form factor, including any combination of computers or variations thereof. One such representative architecture is illustrated in FIG. 7 with respect to computing system 710.

Those skilled in the art will appreciate that various components (not shown) may be included in computing devices 110A-110N to enable network communication with communications network 120. In some cases, communications network 120 may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

Roaming clipboard 130 can allow material (e.g., files, text, code, pictures, objects, etc.) copied from one computing devices 110A-110N to be easily and effortlessly pasted on a second computing device 110A-110N. In some embodiments, cloud-based document storage platform or service 150 can receive a first request to open a document on a first computing device via communications network 120. The cloud-based document storage platform or service 150 can verify the identity of the requestor and allow or deny access to the document. Once the document is opened, data (e.g., text, pictures, or other material) can be copied from the document opened on the first computing device 110A-110N. The copied data can be received and stored using roaming clipboard 130.

In some embodiments, roaming clipboard 130 can store the data copied from the first computing device in a side car file associated with the document that it was copied from, using a buffer associated with the user, in a temporary memory, or the like. The data can then be transmitted to a second computing device to allow the user to paste the data in a selected location at the second electronic device even though the copy command originated at the first electronic device. In some embodiments, entries in roaming clipboard 130 may be associated with the document or file opened via the cloud-based document storage platform or service 150. However, other embodiments allow for roaming clipboard 130 to associate the entry with a user. As a result, that entry is available on any device the user is utilizing.

In other embodiments, roaming clipboard 130 can store a sharable link that points to the content on the user's device where the data was copied. As a result, when the user goes to a different device and pastes the content, the second device asks the roaming clipboard service to return the contents of the link stored at the roaming clipboard. Additionally, the roaming clipboard 130 can instruct the first device to send the information directly to the second device using a communication channel such that the information transparently appears to the user that the information gets from the first device to the second device by a simple copy on the first device and a paste on the second device without any additional effort by the user. One benefit of these embodiments is that the data is not cached in the cloud for privacy concerns or may only be temporarily piped through the cloud in an encrypted format, and the link can be shared with one or more users on a team collaborating on a set of documents.

For example, a user can select some text or a picture on a first computer and choose copy&share vs. just copy, and then add one or more users or alias for a group of users to share the clipboard. Users who have a clipboard available can select a special paste operate such as “paste from user1” in the UI or via other command like a voice command and the clipboard from userl copied to the service will be copied to the second computer. Users may receive a copy paste buffer available notification when a buffer is shared with them. In some embodiments, users can only have one pending buffer from a user at a time the new buffer overwrites the pervious copy. In other embodiments, users can have more than one buffer pending for a paste operation from one or more users.

While a user can easily mentally track a copy on a desktop computer and paste the buffer on a mobile device, it can become more complicated to track the available copy/paste buffers as more become available from multiple colleagues collaborating on a document or project. The additional complexity can be addressed by the operating system or applications improving the user interface to provide a view or notification when new copy buffers become available from various users. These new available buffers may appear in the border of a collaboration document or a dedicated list view of available paste buffers and include metadata such as the application they came from, the user, the size of the buffer, its preferred format such as txt or jpg, executable code or scripts, etc.

The paste operation can show clipboard metadata such as when sender performed the copy operation, how big the buffer is, provide the user a choice of available buffers, etc. The paste can have a small tile of what the paste buffer contains when the user hovers over the paste buffer from the user, as one example of a way to snoop what is on the clipboard from the various users. The available paste buffers can appear in the notifications on the system, such as “User Jane has shared a 3KB copy & paste buffer with you.” and may include a thumbnail image of the buffer. In some circumstances, like loss of network connectivity, the paste operation can fail if the first device goes offline before the paste operation completes. The roaming clipboard may maintain the link for a while in case the first device comes back online or it may delete the link if its unavailable right away or after a short time. An unlikely scenario if a user is concurrently making the copy/paste operations in real time.

The copied data can be stored in a variety of formats and with a variety of additional information or metadata. This additional information or metadata may be presented to the user as optional information to include in pasting options. For example, some paste operations may allow the user to insert the copied data as an image, as a file, as an attachment, or the like. The pasting command may originate via a graphical user interface, keyboard keystrokes, mouse clicks, onscreen touch enabled buttons, voice commands, user interface that supports gestures, etc.

As an illustrative example, suppose a user opens an e-mail on a mobile computing device for an airline reservation. The user would like to copy a portion of the contents of the e-mail using a rich full featured desktop document editing software and the full convenience of the mouse and keyboard enabled desktop application and then paste it into a specific mobile application that is not available on a desktop computer such as Instagram. The user may open the email on the desktop and use a rich desktop document editing software to copy a specific region of the airline email which will copy that new edit to the roaming clipboard 130. Then, the user can return to their mobile device. When the user submits a paste request on the mobile device, the data from the e-mail edited on the desktop and copied to the roaming clipboard is copied to the mobile device and is effortlessly pasted within the mobile specific application from the roaming clipboard 130.

As another illustrative example, a colleague named Jane Doe at Contoso.com wants to send Jim Doe the Wi-Fi password to a network so you can log into the network on your mobile phone and laptop. Jane can copy the text from a document containing several network passwords, and select to share just the one password text with Jim Doe via appropriate contact information. Jim can then receive a notification that Jane Doe is sharing a clipboard. In response, Jim goes to the Wi-Fi password box on his mobile phone and then laptop and selects paste to see an option “paste from JaneDoe@contoso.com.” As a result, the password information is filled in by the phone and then by the laptop which each accessed the link to the roaming clipboard 130 shared by Jane Doe.

The first paste to the phone accessed the roaming clipboard 130 via the phone's data connection with the mobile operator's network, and the laptop used Bluetooth to connect through the phone Wi-Fi connection and access the roaming clipboard 130. One benefit is Jim Doe did not have to open an email, copy the text from the email and then paste the text into the phone and repeat same procedure using the laptop. Jim Doe also avoided taking five minutes of meeting time to accomplish a simple task like sharing access. The Wi-Fi example represents a more general user case where a sender can selectively share a small excerpt of content from a document for which the receiver does not have access and should not receive access. Moreover, the receiver does not want to bother staging the data in a temporary document or email/text message and have to copy and paste the data again.

In some scenarios, extending the Wi-Fi password case, the password input field may be the only application on the device that is given access to the copy buffer so that receivers never see the Wi-Fi password information in plain text, i.e. Jim Doe cannot paste the Wi-Fi buffer into a social networking messaging application. The data may be copied to the cloud in a format that can only be encrypted by the Wi-Fi application or the operating system of the device performing the paste. Some embodiments could use asymmetric or symmetric key encryption for example with a public key or secret such that the sender can target not only a user but an app used by the user on the destination platform.

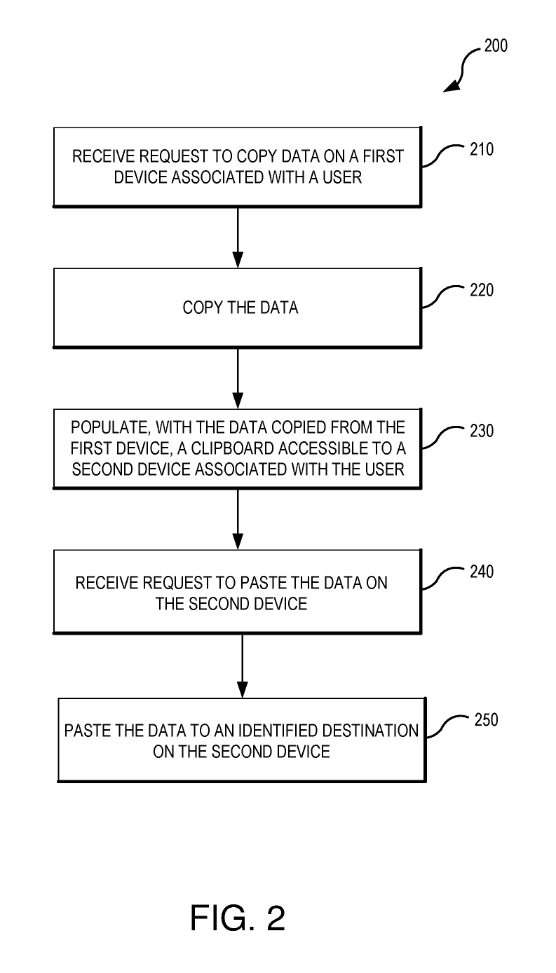

FIG. 2 illustrates an example of a set of operations 200 for copy and paste operations according to one or more embodiments of the present technology. Some or all of the steps of the enhanced copy and paste process 200 may be implemented in program instructions in the context of the component or components of the application or utilities used to carry out the copy and paste actions. In accordance with various embodiments, some of the operations illustrated in FIG. 2 can be built into the office productivity applications (e.g., Excel), implemented by a Visual Basic for Applications (VBA), or implemented in a macro script added by the user or vendor to the application.

During receiving operation 210 a request to copy data can be detected or received. The request can originate from a first electronic device and may be associated with a user's account. For example, the data may be from a selected from a document opened using document storage platform or service 150 (see, e.g., FIG. 1). As another example, the operating system or an application running on the first electronic device may be registered with a particular user. Copy operation 220 can copy the data and/or metadata associated with the selected material.

This data and/or metadata can be used by population operation 230 to populate one or more clipboards or storage locations accessible to a second device associated with a user. In accordance with various embodiments, the data may be stored in a variety of locations including side-car files, buffer, or memory in a layout that facilitates accessing the data and/or metadata as needed. In some embodiments, the clipboards (e.g., local clipboards and roaming clipboards) may employ an object-oriented design that includes an object type that keeps track of locations containing different data types. The object may contain the information or references to the memory containing the different data types. Pasting operation 250 can cause the data to be pasted to an identified destination on a second device.

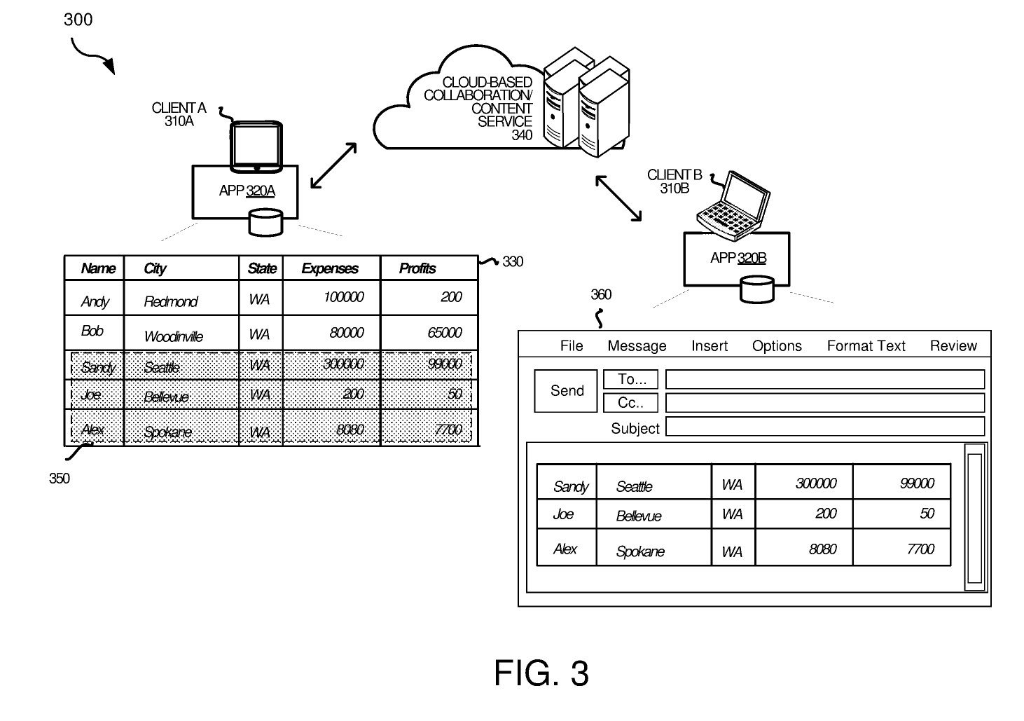

FIG. 3 illustrate a set of components associated with a cloud-based collaboration service supporting an enhanced copy and paste that may be used in one or more embodiments of the present technology. As illustrated in FIG. 3, first client device 310A runs application 320A that can access document 330 from collaboration or content service 340. Collaboration or content service 340 may be a share drive or service capable of storing any form of electronic data that can be opened on a client device. For example, collaboration or content service 340 may provide shared access to cloud-based or centralized content and centralized storage for workbooks such as, for example, Microsoft® Office 365, Microsoft® SharePoint® Online (SPO) services, SharePoint®, a shared network drive, or the like. In accordance with various embodiments, application 320A may include office productivity applications such as, but not limited to, e-mail applications, word processing applications, note taking applications, spreadsheet applications, and the like.

In some embodiments, the collaboration service can also be embedded in clients 310A and 310B and may be communicatively coupled using a network connection (e.g., Wi-Fi, Ethernet, Bluetooth, 3G, 4G, 5G, LTE etc.) or operate as a cloud based service. The collaboration service can include services like file sharing, messaging, with users logged into the service with an account and various contact methods such as phone, text, email, and various messaging application and social network profiles with contact information.

As shown in the example of FIG. 3, document 330 can be opened on client device 310A with application 320A. Application 320A can include functionality including GUIs (graphical user interface) running on client device 310A, e.g., a PC, mobile phone device, a Web server, or other application servers. Such systems may employ one or more virtual machines, containers, or any other type of virtual computing resource. Once opened, a user can select a portion 350 of document 330 using standard cell selection techniques (keystrokes, mouse inputs, touch inputs, voice commands including interacting with artificial intelligence service such as Microsoft's Cortana Assistant, combination of aforementioned, etc.) and request that portion 350 be copied using a menu or other command interface (e.g., keyboard shortcut, voice command, etc.).

Portion 350 may be stored in a local clipboard associated with an operating system of client device 310A or application clipboard. In some embodiments, portion 350 may be transmitted to cloud-based collaboration and content service 340. In some embodiments, a reference, link, or Universal Resource Identifier (URI) that points to the content 350 in the application 320A can be stored in a local clipboard associated with an operating system of a client device 310A or application clipboard or shared with another device using a variant of the aforementioned cloud based collaboration service 340 or shared directly with client 310B operating system or application 320B leveraging network connections like Bluetooth, WIFI, 4G, 5G, LTE, caching on portable storage, and the like.

The transmission to collaboration and content service 340 may include additional information and/or metadata in addition to copied portion 350. This additional information and/or metadata can include, but is not limited to information identifying document 330, the user, client device 310, application 320, and/or other information. Portion 350 along with the additional information or metadata can be stored in a variety of formats. This additional information or metadata may be presented to the user as optional information to include in pasting options.

When the user logs into collaboration or content service 340 via client device 310B, client device 310B may access portion 350 copied from client device 310A. Client device 310B may directly access portion 350 within collaboration or content service 340 or have a copy loaded into a local clipboard, memory, or buffer on client device 310B. The user can then request (e.g., using menu or other command interface that portion 350 be pasted into a new location on client device 310B. In accordance with some embodiments, there may be multiple options for how portion 350 is pasted. For example, portion 350 could be pasted into e-mail 370 as illustrated in FIG. 3. Various embodiments allow for the user to insert the copied portion 350 as an image, as a file, as an attachment, or the like. The pasting command may originate via a graphical user interface, keyboard keystrokes, voice commands including interactions with artificial intelligence service such as Microsoft's Cortana Assistant, mouse clicks, onscreen touch enabled buttons, user interface that supports gestures, etc.

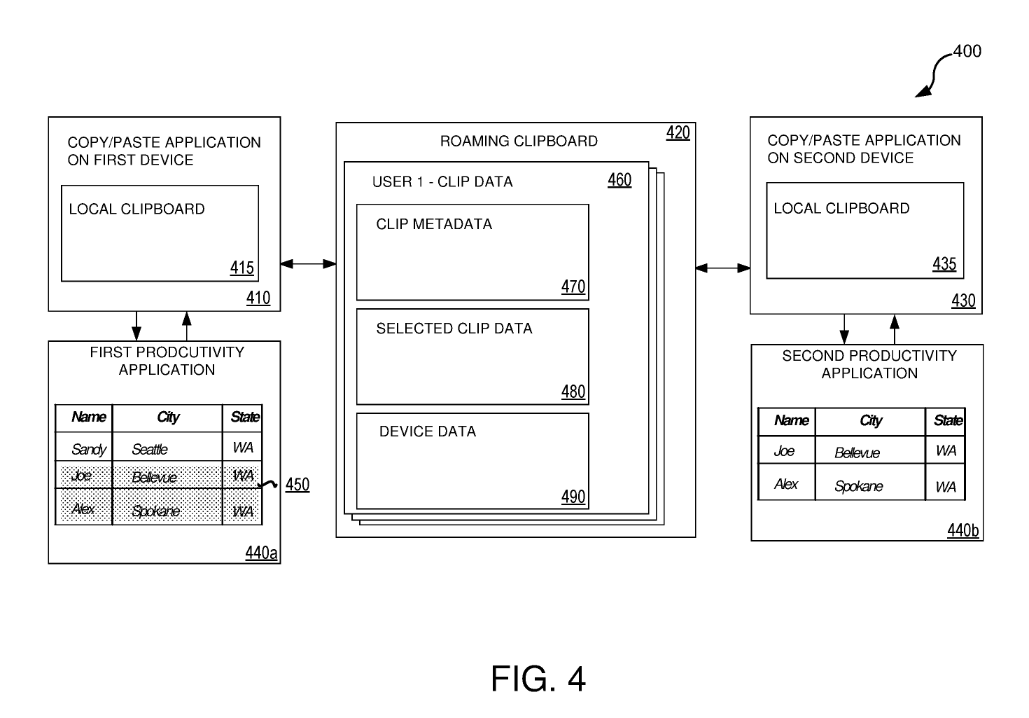

FIG. 4 illustrates a set of components 400 that may be used according to one or more embodiments of the present technology. According to the embodiments shown in FIG. 4, the system can include copy/paste application 410 on a first device with access to local clipboard 415, roaming clipboard 420, copy/paste application 430 on a second device with access to local clipboard 435, and one or more productivity applications 440a-440b. In accordance with various embodiments, a user can use copy/paste application 410 or copy paste application 430 to copy material (e.g., data, pictures, images, code, text, files, etc.) from productivity application 440a or 440b to the other using roaming clipboard 420. Each of these applications or modules can be part of operating system utilities, cloud-based platforms (e.g., accessed via a webpage or other portal), productivity applications, a feature of a larger application like a spreadsheet or word processing application, and the like.

In one embodiment, the Microsoft Foundation Class (MFC) Library provides two classes, the Data Sources (CO1eDataSource objects) represent the source side of the data transfer (e.g., from copy/paste application 410 to roaming clipboard 420) and Data object (CO1eDataObject objects) represent the destination side of the data transfer from roaming clipboard 420 to copy/paste application 430. These local copy/paste services can be extended to reach into the temporary cloud hosted roaming clipboard 420. In some embodiments, the roaming clipboard can be a proxy that connects the client copy objects and buffers with the destination paste operation. In some embodiments, these MFC classes can be extended to support remote interfaces. How to use these basic software objects and interfaces to copy and paste information that adds an additional data format type to and from the clipboard is fully described by Microsoft Developer Network MSDN documentation “OLE in MFC” (available at URL:https://msdn.microsoft.com/en-us/library/df267wkc.aspx and incorporated by reference) including sub topics “Clipboard: Copying and Pasting Data” (URL: https://msdn.microsoft.com/en-us/library/2ca18w7k.aspx incorporated by reference) and “Data Object and Data Sources (OLE)” available at URL https://msdn.microsoft.com/en-us/library/w1c8ka59.aspx incorporated by reference). Other embodiments of the present technology may include some, all, or none of these modules and components along with other modules, applications, and/or components. Still yet, some embodiments may incorporate two or more of these modules, applications, and components into a single module or application and/or associate a portion of the functionality of one or more of these modules with a different module or application. For example, in one embodiment, copy/paste application 410, roaming clipboard 420, and paste/paste application 430 can be combined into a single copy/paste application hosted on a cloud-based server.

In various embodiments, the client application running on 410 can store the copy buffer on roaming clipboard 420 and optionally specify access control lists (ACL) information that limit the client devices, user, groups of users, or applications that can paste the data. Remote client 430 can leverage cloud enabled interfaces that include access credentials such as the users access tokens, device credentials, etc. to retrieve the information in the format appropriate for the paste operation. Some embodiments can simply be a globally shared URI or buffer, or file containing the content that is accessible by the user's account from each machine and invoked to write the data during a copy operation by the application, and read from the roaming clipboard by a paste operation.

In some embodiments, roaming clipboard 420 can be implemented as an application interface to 410 and 430 that sits on top of an email account or messaging service. As a result, a copy operation can paste a message to the text or email message. Similarly, the paste operation can transparently retrieve the attachment from the message and paste the attachment when requested by the user without the user having to actually dig out the message from the email or text message. In some embodiments, the messages copied and pasted to the email or messaging applications include metadata such as the collaboration document URL and collaborators so that the pasting application at the receiving end can find and filter the received copied buffers to a relevant list for a user editing different documents. Some messaging applications have features where the message is not retained by the sender and the message is deleted after being read by the recipient(s), which avoids the system from accumulating a list of stale copy/paste buffers. In some embodiments, the roaming clipboard is a simple shared buffer that client 410 can write to the buffer and client 430 reads from the buffer when desired by the user and the access control is handled by the user's permissions to the hosted URL or web service performing the message store/retrieval.

A user can select data from table 450 in productivity application 440a. Upon requesting the data be copied, copy/paste application 410 identifies the user selected data copies the data into one or more clipboards. In some embodiments, the user may select either a local clipboard 415 or roaming clipboard 420. In some embodiments, the user can select who to share the copy buffer with. In some embodiments, the user chooses from which user to paste. In some embodiments, a user can share with a specific user who simply performs a paste of the information automatically forwarded to their copy buffer and available to paste. In various embodiments, all copy requests may copy the material into local clipboard 415 which is then mirrored on roaming clipboard 420 (e.g., in response to one or more events such as, but not limited to, a save command, a periodic schedule, request from roaming clipboard, etc.). Roaming clipboard 420 can store a variety of data types, such as, but not limited to text strings, data structures, text and binary stream data, and even application assets.

Clipboard data can be classified using various mechanisms such as Multipurpose Internet Mail Extensions (aka MIME types) which follow the Internet Engineering Task Force Request for Comments RFC 2045 (available at www.ietf.org/rfc/rfc2045.txt and incorporated by reference) and RFC 2046 (available at www.ietf.org/rfc/rfc2045.txt and incorporated by reference). Roaming clipboard 420 can store multiple copies of the data in individually enumerated buffers associated with a user, file or other distinguishing structure with descriptors for the data. The copy buffers may be enumerated and identified by well-known identifiers (ID's) (such as those documented by MSDN “Clipboard Formats” available at https ://msdn.microsoft.com/en-us/library/windows/desktop/ms649013(v=vs .85).aspx#_win32_Standard_Clipboard_Formats and incorporated by reference), MIME types or support custom data formats denoted by custom identification (ID) identifiers including an embodiment taught by MSDN “Clipboard: Adding Other Formats” (available at URL: https://msdn.microsoft.com/en-us/library/838a3whf.aspx and incorporated by reference), private clipboard formats only understood by certain applications, etc.

Roaming clipboard 420 can copy the data to the buffers on the copy command in various formats filling the appropriate buffer, or be deferred and simply keep track of the data marked for copy which is then performed when the data is pasted to a destination and the destination application requests the buffer or buffers from the application performing the copy operation. Roaming clipboard 420 can be implemented by a cloud-based service that will provide access to the data buffers to multiple devices. In accordance with various embodiments, copy/paste application 410, roaming clipboard 420, and/or copy/paste application 430 may be implemented in a variety of ways including, but not limited to, java script (e.g. as a plug in to a browser or productivity suite), web-based, operating system utilities, application features, etc.

Copy/paste application 410 and 430 and roaming clipboard 420 may store the data in different ways depending on the data type. In some embodiments, the data may be split into different portions for complex data. For example, simple text data can be stored directly in roaming clipboard 420, while more complex data can be stored using references that copy/paste application 430 can resolve and use to reconstruct the data in a desired format. In some embodiments, clip data 460 can include metadata 470, selected clip data 480 and device or user data 490. Clip data 460 can include parameters such as access control lists, user access lists, device access permissions and the like to ensure only authorized users can access the clipboard data during the copy and paste scenario from start to finish. Using this type of organization, copy/paste application 430 can access parts of the data that are needed based on the originating device (or user, etc.) and reconstruct the data for pasting, possibly in alternate formats as requested by a user. For example, copy/paste application 430 may paste just the clip data, paste the selected data in the table format, etc. As another example, the text from table 450 could be XML or HTML table markup that gets copied to clipboards 415, 420, and/or 430. A copy/paste of HTML in the middle of a set of data can result in the data being copied to roaming clipboard 420 in a reduced format.

In some embodiments, the roaming clipboard data 460 can be deleted after the user closes application 440a. In some embodiments data 460 can be deleted when the user logs out of all systems. Still yet, in at least one embodiment, data 460 can be deleted when the user pastes the data into application 440b. Some embodiments delete the data after a time out of five minutes, other scenarios the user is asked if they want to keep the buffer when they exit an application. When the user chooses yes, data 460 can be preserved for a longer timeout such as twenty-four hours, a week, or some other period of time. The value can be configured by a system administrator or can even be a user configurable setting by the copy and/or paste client.

In some embodiments, the roaming clipboard can keep a reference count to the number of active clients that have a copy of the buffer available, when the count goes to zero the data 460 can be deleted or the link to the data provided by 460 can be deleted. In some embodiments, the user can clear all clipboard buffers using a command, select copy/paste buffers for deletion. Some applications supporting the copy/paste buffers may preserve copy/paste buffers between application uses, across various documents or buffers may be limited to copy and paste from specific documents or applications. The user can even filter available buffers from specific users or documents, projects, teams, etc.

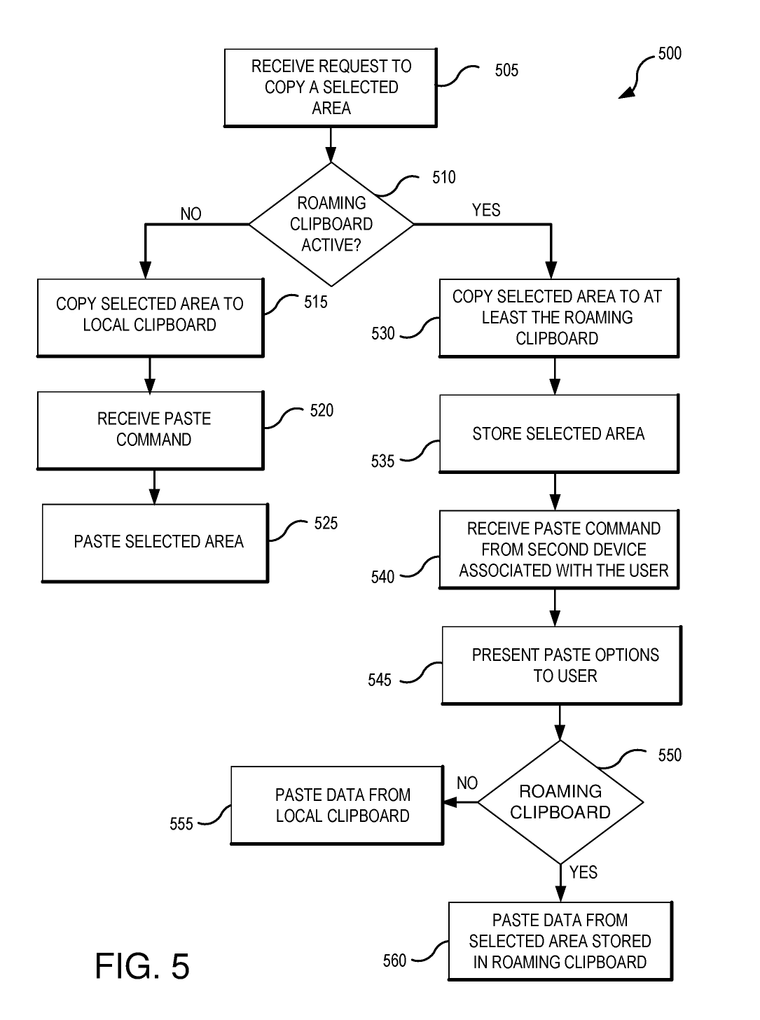

FIG. 5 illustrates an example of a set of operations 500 for allowing a user to paste data from local and/or roaming clipboards in accordance with some embodiments of the present technology. As illustrated in FIG. 5, receiving operation 505 detects a request to copy a selected area or material on a first device. In response to detecting the request to copy a selected area, determination operation 510 determines whether a roaming clipboard is active. In some embodiments, the first device can automatically query the location of the roaming clipboard to determine availability. If determination operation 510 determines that the roaming clipboard is not available, then determination operation 510 branches to copy operation 515 where the selected area or material is copied to a local clipboard on the first device where the copy request originated. When a request to paste the data is detected via during receiving operation 520, pasting operation 525 pastes the selected area to a selected location on the first device.

If determination operation 510 determines that the roaming clipboard is available, then determination operation 510 branches to roaming operation 530 the copied data or material is copied to at least the roaming clipboard. In some embodiments, the data or material may first be copied to a local clipboard before being transmitted to the roaming clipboard. In other embodiments, the data or material may be copied to the local clipboard or roaming clipboard simultaneously. Still yet, the user may be prompted to select which of the clipboards the data should be copied to. Using storage operation 535 the selected area or material can be stored. In some embodiments, the data or material copied from the first electronic device can be stored in the cloud (e.g., within a cloud-based document storage platform) in a side car file appended to a document, using a buffer associated with the user, in a temporary memory, or the like. In some embodiments, a link to the content on the first device can be stored in the cloud-based storage, and when the user performs a paste operation the cloud resolves the link to either copy the data from the first device or the first device sends the data to the second device as two possible implementations.

When receiving operation 540 receives a paste command at a second device, presentation operation 545 follows which can present the user with multiple paste options (e.g., to paste from a local clipboard or from the roaming clipboard). Selection operation 550 determines which clipboard option the user has selected. When selection operation 550 determines that the user has not selected to paste the data from the roaming clipboard, then selection operation 550 branches to local pasting operation 555 where the data from the local clipboard is pasted. When selection operation 550 determines that the user has selected to paste the data from a roaming clipboard, then selection operation 550 branches to pasting operation 560 where data from the roaming clipboard can be pasted.

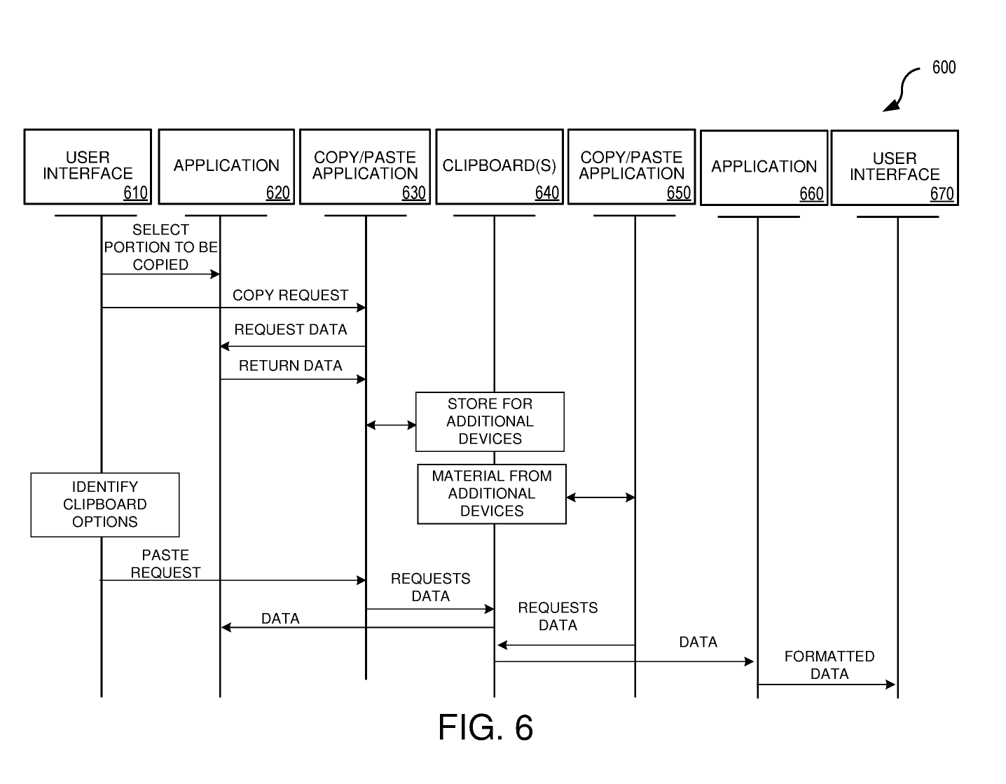

FIG. 6 is a sequence diagram 600 illustrating an example of the data flow between various components according to various embodiments of the present technology. As illustrated in FIG. 6, a user utilizes user interface 610 to select a material presented on a first device in application 620. Application 620 is representative of any software application capable of creating data that can be copied and pasted. Examples include, but are not limited to, spreadsheet applications, word processing applications, presentation applications, email applications, social networking applications, messaging applications, web browser applications, gaming applications, business management applications, note taking applications, video or image editing applications, and any other type of combination, variation, or combination thereof. Application 620 may be implemented as a natively installed and executed application, a browser-based application, a streaming or streamed application, a mobile application, or in any other suitable manner

As illustrated in FIG. 6, the user can then submit via user interface 610 a copy request which is detected by copy/paste application 630 that can be a clipboard provided by operating system or execution environment runtime (e.g., Java Virtual Machine) or included in application 620 and 650, or a combination thereof. In response to the copy request, the application 620 identifies the selected material (e.g., text, picture, table, etc.) within application 620. Application 620 returns the data to copy/paste application 630 which then formats the data for storage on clipboard(s) 640.

Data stored on clipboard(s) 640 can be in one or more formats such as encoded in XML, a pointer or link to the selected material in the application instead of making a duplicate copy of the data at clipboard(s) 640, rendered as an image and stored on the clipboard in image format, stored as text string, etc. Additional copy/paste applications 650 accessed via additional devices can also add copied material to the clipboard(s) 640.

A user can interact with user interface 610 to identify clipboard options and choose features such as sharing clipboard contents with other users or groups of users. When the user requests the data be pasted from one of the clipboard options, copy/paste application 650 can collect the data from clipboard(s) 640, formats the data (if required), and pastes the data at the desired location within application 620. Alternatively, when the user requests the data be pasted from one of the clipboard options, application 620 can request the data from a clipboard which may make the information available from a single buffer (or object) or may present one or more different formats of the data instead of just a single buffer (clipboard object with multiple interfaces or interface with multiple formats of the originally selected data).

Various embodiments of the present technology may use one or more digital encodings of the content copied to clipboard(s) 640 or returned by the paste operation, the generation of the single or multiple copies of the information selected for copy can be performed by the copy application, system, object oriented programming paradigm of encoding the clipboard as an object with copy and paste methods, a copy and paste application, or a combination thereof.

For example, the copy operation can present simple text data selected at 610 in application 620 to clipboard(s) 640 that invokes copy/paste application 630 to store the data in clipboard(s) 640 that is shared with destination application 660 in a paste operation that is formatted in a different font or the copy operation than originally copied from application 620. In accordance with various embodiments, the encoding of the data can occur anywhere between 610, 620, 630, 640, 650, 660, or 670. The copy buffer can make a digital copy of a jpeg photo selected for “copy and paste” and then clipboard(s) 640 can present both the PNG and JPG formats as available formats to the pasting application 650 when it queries the clipboard 640 via clipboard application 650 to see what kinds of data formats are available on the clipboard 640 for pasting and choose a supported or preferred format via the user interface in the destination application 660 via the user interface 670.

As another example, some embodiments may provide for rich text formatting vs. plain text with no formatting that can be copied to the clipboard by application 620 pasting only the text or application 660 can ask application 620 to provide the data to clipboard(s) 640 in a format desired and cause the action to occur on demand vs at the time the user chooses to copy the data. Other options can be a paste action by application 660 that converts the text or group of text available from clipboard(s) 640 to image vs. keeping it as a text string as placed into clipboard(s) 640 by the original copy operation by clipboard application in application 620 and/or copy/paste application 630 or a combination thereof. All other permutations of the capture of the data, formatting, and presentation are contemplated by the basic components 610 capturing the data to be copied through the replication of the data at completion of the paste action at copy/paste application 660.

FIG. 7 illustrates computing system 710, which is representative of any system or collection of systems in which the various applications, services, scenarios, and processes disclosed herein may be implemented. For example, computing system 710 may include server computers, blade servers, rack servers, and any other type of computing system (or collection thereof) suitable for carrying out the enhanced collaboration operations described herein. Such systems may employ one or more virtual machines, containers, or any other type of virtual computing resource in the context of supporting enhanced group collaboration.

Computing system 710 may be implemented as a single apparatus, system, or device or may be implemented in a distributed manner as multiple apparatuses, systems, or devices. Computing system 710 includes, but is not limited to, processing system 720, storage system 730, software 740, applications for copy/paste process 750, communication interface system 760, and user interface system 770. Processing system 720 is operatively coupled with storage system 730, communication interface system 760, and an optional user interface system 770.

Processing system 720 loads and executes software 740 from storage system 730. When executed by processing system 720 for deployment of scope-based certificates in multi-tenant cloud-based content and collaboration environments, software 740 directs processing system 720 to operate as described herein for at least the various processes, operational scenarios, and sequences discussed in the foregoing implementations. Computing system 710 may optionally include additional devices, features, or functionality not discussed for purposes of brevity.

Referring still to Fig.7, processing system 720 may comprise a micro-processor and other circuitry that retrieves and executes software 740 from storage system 730. Processing system 720 may be implemented within a single processing device, but may also be distributed across multiple processing devices or sub-systems that cooperate in executing program instructions. Examples of processing system 720 include general purpose central processing units, application specific processors, and logic devices, as well as any other type of processing device, combinations, or variations thereof.

Storage system 730 may comprise any computer readable storage media readable by processing system 720 and capable of storing software 740. Storage system 730 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 730 may also include computer readable communication media over which at least some of software 740 may be communicated internally or externally. Storage system 730 may be implemented as a single storage device, but may also be implemented across multiple storage devices or sub-systems co-located or distributed relative to each other. Storage system 730 may comprise additional elements, such as a controller, capable of communicating with processing system 720 or possibly other systems.

Software 740 may be implemented in program instructions and among other functions may, when executed by processing system 720, direct processing system 720 to operate as described with respect to the various operational scenarios, sequences, and processes illustrated herein. For example, software 740 may include program instructions for directing the system to perform the processes described above.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 740 may include additional processes, programs, or components, such as operating system software, virtual machine software, or application software. Software 740 may also comprise firmware or some other form of machine-readable processing instructions executable by processing system 720.

In general, software 740 may, when loaded into processing system 720 and executed, transform a suitable apparatus, system, or device (of which computing system 710 is representative) overall from a general-purpose computing system into a special-purpose computing system. Indeed, encoding software on storage system 730 may transform the physical structure of storage system 730. The specific transformation of the physical structure may depend on various factors in different implementations of this description. Examples of such factors may include, but are not limited to, the technology used to implement the storage media of storage system 730 and whether the computer-storage media are characterized as primary or secondary storage, as well as other factors.

For example, if the computer readable storage media are implemented as semiconductor-based memory, software 740 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

In general, copy/paste process 750 can be hosted in the cloud as a service, distributed across computing devices between the various endpoints, hosted as a feature of a cloud enabled information creation and editing solution. Copy/paste process 750 can capture copies of data selected by users from their devices or links to the data on their device and share these buffers with the same user on another device or with multiple users. The sharing of the buffers can be very secure and encrypt the information or made less insecure to fit the needs of the user and the application that will be exchanging the copy of the data.

Communication interface system 760 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 770 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 770. In some cases, the input and output devices may be combined in a single device, such as a display capable of displaying images and receiving touch gestures. The aforementioned user input and output devices are well known in the art and need not be discussed at length here. In some cases, the user interface system 770 may be omitted when the computing system 710 is implemented as one or more server computers such as, for example, blade servers, rack servers, or any other type of computing server system (or collection thereof).

User interface system 770 may also include associated user interface software executable by processing system 720 in support of the various user input and output devices discussed above. Separately or in conjunction with each other and other hardware and software elements, the user interface software and user interface devices may support a graphical user interface, a natural user interface, an artificial intelligence agent capable of assisting with automation of the copy and/or paste operations (e.g. an enhanced version of Microsoft's Cortana assistant, Amazon's Alexa, or Apple's Siri, Google's Assistant, etc.), or any other type of user interface, in which a user interface to a productivity application may be presented.

Communication between computing system 710 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

The functional block diagrams, operational scenarios and sequences, and flow diagrams provided in the figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A system comprising:
one or more processors;
a communication component to
connect the system to a first client device and a second client device;
receive data copied within an application opened on the first client device;
a storage module to
store the data copied from the application opened on the first client device; and
wherein the communications component transmits the data to the second client device to allow a user to paste the data in a selected location on the second client device.

2. The system of claim 1, wherein the data is a first set of data and second client device includes a graphical user interface generation module to present a graphical user interface in response to a pasting request on the second client device, wherein the graphical user interface includes:
a first option to paste the first set of data copied from the first client device; and
a second option to paste from a local clipboard available only on the second client device.

3. The system of claim 1, wherein the application is hosted remotely from the first client device and accessed by a user using a username and password and wherein the storage module stores the data copied from the application opened on the first client device in a buffer associated with the user.

4. The system of claim 1, wherein the data copied from the application on the first client device is automatically transmitted in response to a user saving a file, according to a transmission schedule, or upon request from the storage module.

5. The system of claim 1, wherein the storage module stores the data copied from the first client device in a roaming clipboard that includes different data structures with metadata identifying a user associated with first client device.

6. A computer-readable medium having instructions stored thereon instructions that when executed by one or more processors cause a machine to:
receive data copied from a document opened on a first electronic device;
store the data copied from the first electronic device; and
transmit the document and the data copied from the first electronic device to a second electronic device to allow a user to paste the data in a selected location on the second electronic device.

7. The computer-readable medium of claim 6, further comprising instructions that when executed by the one or more processors further cause the machine to:
receive a request from a user to access the document on the first electronic device;
allow the first electronic device to access the document; and
receive a request from the user to access from the second electronic device.

8. The computer-readable medium of claim 7, wherein the instructions when executed by the one or more processors cause the machine identify the user and store the data copied from the first electronic device in a cloud-based clipboard that can be accessed from either the first electronic device or the second electronic device.

9. The computer-readable medium of claim 6, wherein the data copied from the document opened on a first electronic device is stored in a side car file associated with the document.

10. The computer-readable medium of claim 6, wherein the data copied from the document on the first electronic device is automatically transmitted to the machine in response to a user saving the document, according to a transmission schedule, or upon request from the machine.

11. The computer-readable medium of claim 6, wherein the data copied from the first electronic device is stored in a clipboard that includes different data structures with metadata identifying the document and a user associated with the document.

12. The computer-readable medium of claim 6, wherein the data copied from the first electronic device is loaded into a local clipboard of the second electronic device.

13. The computer-readable medium of claim 6, wherein the instructions when executed by the one or more processors cause the machine to receive a second set of data copied from the document at the second electronic device and transmit the second set of data to the first electronic device to allow the user to paste the data in a selected location on the first electronic device.

14. A method comprising:
receiving, at a cloud-based document storage platform, a first request to open a document on a first electronic device;
receiving, at the cloud-based document storage platform and from the first electronic device, data copied from the document on the first electronic device;
storing, at the cloud-based document storage platform, the data copied from the first electronic device; and
transmitting, from the cloud-based document storage platform, the data to a second electronic device to allow the data to be pasted in a selected location.

15. The method of claim 14, wherein the data copied from the first electronic device is stored at the cloud-based document storage platform in a side car file appended to the document.

16. The method of claim 14, wherein the first request to open the document is associated with a user, and wherein the data copied from the first electronic device is stored at the cloud-based document storage platform using a buffer associated with the user.

17. The method of claim 14, wherein the data copied from the document on the first electronic device is transmitted to the cloud-based document storage platform in response to a user saving the document, according to a transmission schedule, or upon request from the cloud-based document storage platform.

18. The method of claim 14, wherein the cloud-based document storage platform allows the document to be simultaneously opened on a second electronic device.

19. The method of claim 18, further comprising transmitting, in response to detecting that the document was simultaneously opened on the second electronic device, the data copied from the document on the first electronic device is transmitted to the cloud-based document storage platform.

20. The method of claim 19, further comprising pasting the data upon receiving, from the second electronic device, a request to paste the data copied at the first electronic device.
